(19) United States
(12) Patent Application Publication
(10) Pub. No.: US 2017/0215995 A1
(43) Pub. Date: Aug. 3, 2017

(54) DENTAL IMPLANT

(71) Applicant: ERIC ROMPEN IMPLANTOLOGIE, Liège (BE)

(72) Inventor: Eric Rompen, Embourg (BE)

(73) Assignee: ERIC ROMPEN IMPLANTOLOGIE, Liège (BE)

(21) Appl. No.: 15/328,568

(22) PCT Filed: Jul. 28, 2015
(86) PCT No.: PCT/EP2015/067261

§ 371 Date: Jan. 24, 2017

(30) Foreign Application Priority Data
Jul. 30, 2014 (BE) 2014/0586

(51) Int. Cl. A61C 8/00

(52) U.S. Cl. CPC A61C 8/0022; A61C 8/006; A61C 8/0068

(57) ABSTRACT

The invention relates to a dental implant consisting of an anchoring body defined between an apical end and a cervical end, wherein said anchoring body is a body having a first predetermined length and, on the outer surface thereof and along the entirety of said first predetermined length, at least one thread, wherein said anchoring body has, over at least a coronal portion, a portion of said at least one thread that has a nominal diameter that is greater than an outer diameter of said anchoring body at a first ratio of 2.00 to 4.00, preferably 2.00 to 3.00.

The present invention relates to a dental implant formed by an anchoring body defined between an apical end and a cervical end, said anchoring body being a body with a first predetermined length and having, on its outer surface and along all of said first predetermined length, at least one thread.

Preferably, the dental implant is made from titanium, but an alternative to titanium to produce the dental implant consists of zirconium, an alloy of these two elements, or any other biocompatible material.

A dental implant is traditionally used to produce a dental prosthesis, in order to restore a chewing function, mouth comfort and aesthetics to a patient who has lost some or all of his teeth.

To that end, when the implant is placed, the latter is first fixed by screwing in a housing formed beforehand in the bone of the jaw, on an implantation site. Next, a prosthetic element, fixed or removable, is placed on the implant via a pier or cervix: one therefore obtains a prosthesis made up of the prosthetic element mounted on a prosthetic assembly comprising the implant and the cervix or pier.

In general, the dental implants known from the state of the art are formed by a threaded anchoring body with an outer diameter comprised between 3 mm and 6 mm, the diameter being chosen so as to allow a distribution of pressure loads upon placement of the prosthetic element and during chewing.

Document U.S. Pat. No. 3,466,748 describes a dental implant having an anchoring body comprising several separate parts: a first threaded part whereof the diameter of the turns (making up the thread) is constant over the entire height and a second part whereof the diameters of the turns (making up the thread) decrease along the dental implant toward its apical end. The anchoring body also has non-threaded parts, including the end portion of the anchoring body in contact with the support of the prosthesis: the coronal part of the dental implant according to this prior document is therefore not threaded. Furthermore, the dental implant according to this prior document has a central part that is not threaded between the first and second threaded part, which is problematic when the dental implant must be removed. Indeed, when the bone tissues reform bone around the central part of the dental implant, the latter is practically blocked and cannot be unscrewed, since the threaded parts are separated by the reformed bone.

Document WO2011/085982 also discloses a first dental implant whereof the coronal part is not threaded and a second dental implant whereof only two separate parts have threads. More particularly, according to this second dental implant described in this prior document, the two threaded parts are intended to be localized in the cortical bone, while the central part of the dental implant situated between these two threaded parts has no thread. This is therefore a bi-cortical anchoring responsible for lateral deflection that creates fixing problems of the dental implant at the cervix of the latter. Indeed, the cortical bone being more dense than the cancellous bone, if the apical part of the dental implant is fixed in the apical cortical bone, the flexibility of the implant is reduced and greater pressure is exerted on the cervical cortical bone. That is why it is greatly preferable for the apical part of the dental implant to be situated in the cancellous bone.

Furthermore, this type of dental implant, like that described in document WO2011/085982, is used less and less, on the one hand due to problems related to lateral deflection, and on the other hand because they cannot be removed by simple unscrewing. Indeed, like for the dental implant disclosed in document U.S. Pat. No. 3,466,748, once the bone tissues reform bone around the central part of the dental implant, the latter is practically blocked and cannot be unscrewed, since the threaded parts are separated by the reformed bone.

Document WO2010/021478 discloses a dental micro-implant (miniature implant) having threads with an increasing diameter from the cervical part toward the apical part: the diameter of the turns making up the thread is therefore smallest at the coronal part of this dental implant of the state of the art.

Unfortunately, with these implants of the state of the art, the stability of the peri-implant bone is not systematically guaranteed. Indeed, postoperative bone loss in the form of craters frequently appears after a certain amount of operating time, and is accompanied by a loss of attachment of the peri-implant mucosa characterized by the formation of pockets between the gums and implants in which penetration of the buccal bacterial flora is observed. Furthermore, as indicated above, some of these dental implants cannot be unscrewed, as they are practically blocked in the bone reforming around the dental implant.

It is suggested that peri-implant bone loss of the cervical cortical bone may have different causes:
on the one hand, these losses may be caused by a lack of attachment of the mucosa, for example related to: (i) a lack of biocompatibility of the cervix or pier, (ii) excessively frequent unscrewing of the piers, (iii) inappropriate prosthetic techniques; and/or
on the other hand, these losses may be caused by bone destruction caused either by high chewing stresses causing excessive shearing forces at the bone/implant interface, or by potential deformations of the walls of the implant body.

The loss of bone mass of the cervical cortical bone (by definition not highly vascularized) defined on the periphery of one cervical end of the implant causes a reduction in the mechanical stability (primary stability) and a gradual increase of the extra-bone lever arm, which gradually amplifies the mechanical stresses exerted on the residual bone anchoring and therefore a possible acceleration of bone destruction.

Aside from the loss of mechanical qualities of the implant and therefore chewing capacities of the patient, the loss of bone mass may be responsible for withdrawal of the gums on the implantation site, which has two major consequences. On the one hand, the loss of bone mass leaves part of the cervix or pier of the prosthetic assembly visible, which decreases the aesthetic quality. On the other hand, the loss of bone mass corresponds to a loss of the natural barrier to bacteria present in the buccal cavity, which, when the gum loss is great enough around the cervix or pier, may become lodged between the implant and the gums, which quickly results in inflammation of the gums.

More dramatically, bacteria may penetrate and colonize the bone mass, which results in the appearance of infections or the formation of abscesses in the bone, which are particularly difficult to treat.

There is therefore a need to obtain a dental implant that makes it possible to decrease, or even destroy, these postoperative peri-implant bone losses of the cervical cortical bone. There is also a need to procure a dental implant that can easily be unscrewed, for example to be replaced.

To offset this need, provided according to the invention is an implant as described above, characterized in that said anchoring body has, over at least a coronal portion of the implant, a portion of said at least one thread with a nominal diameter dₙ that is greater than an outer diameter dₑ of said anchoring body at a first ratio dₙ/dₑ comprised between 2.00 and 4.00, preferably between 2.00 and 3.00.

In this way, due to the ratios between the nominal diameter of the thread and the outer diameter of the anchoring body provided according to the invention, an implant is obtained having a mechanical stability that is preserved while reducing the pressure exerted in the cervical cortical bone.

Indeed, in the context of the present invention, it has surprisingly been observed that not only by reducing the diameter of the anchoring body and increasing the diameter of said at least one thread at a first ratio dₙ/dₑ comprised between 2.00 and 4.00, the mechanical stability of the implant was not deteriorated, but on the contrary, the mechanical stability of the implant is increased over the long term.

According to the invention, it has also been determined that such a ratio must at least be observed at the coronal part (portion) of the dental implant. Within the meaning of the present invention, the terms “coronal part or portion of the dental implant” refer to the intra-bone part (or portion) of the dental implant that extends over a length of 2 to 5 mm, preferably over a length of 3 to 4 mm from the cervical end of the dental implant toward the apical end of the latter.

According to the invention, it has been shown that reduced trauma caused at the bone/implant interface by chewing forces is obtained by increasing the nominal diameter (and therefore the width of the turns) of the screw pitch, which makes it possible to increase the bone/implant contact surface, increase the bone/implant keying, and compress the bone while decreasing the shearing forces.

It has further been observed that an implant body that is less hollow than the implants of the state of the art, which house a deep inner housing to accommodate the pier screw, also makes it possible to reduce the deformations of the implant walls of the implant under the chewing forces.

This aim is achieved by significantly reducing the diameter of the implant body, in particular in the cervical part, and increasing the width of the turns to ensure good anchoring in the hard cortical bone. Furthermore, wide turns make it possible to create space to generate well-vascularized cancellous bone between the turns, to reduce the implant material (e.g., titanium)/bone weight ratio, while preserving high primary stability (or mechanical stability) when placing the implant and therefore stabilization (or improvement) of the anchoring of the implant body over time.

In other words, in the context of the present invention, it has been determined that a dental implant according to the invention has three main advantages without decreasing the primary stability of the implant (mechanical stability), i.e., without decreasing the anchoring of the turns of the thread of the dental implant in the peripheral bone:
the contact surface of the dental implant is increased, which makes it possible to better distribute the mechanical stresses to which the dental implant is subjected;
the compressions of the dense/hard bone (cortical bone) and cancellous bone are increased, which stimulates rapid reformation of the bone tissue (therefore the bone) around the dental implant; and
a large quantity of living bone can reform around the dental implant inasmuch as its thread has turns with a large diameter between which the bone tissues can reform and fix (bone regeneration between large turns along the entire dental implant), which increases the BIC (Bone to Implant Contact).

Advantageously, said anchoring body is at least partially substantially cylindrical or has a conical-cylindrical shape or conical shape with its taper converging toward said apical end.

Advantageously, said coronal portion is defined by a side wall that has a first vestibular face and a second palatine face, said palatine face being in a position offset toward said cervical end relative to that of the vestibular face along a longitudinal axis traversing the anchoring body and connecting said first cervical end to said apical end.

Optionally, the anchoring body has, at its apical end, at least one tapping notch made up of at least one longitudinal recess, preferably arranged from the apical end toward the cervical end of the anchoring body.

Other embodiments of the dental implant screw according to the invention are indicated in the appended claims.

The present invention further pertains to a prosthetic assembly comprising:
said implant according to the invention; and
a transgingival element, intended to traverse the gums and arranged to be connected to the coronal portion of the anchoring body. This transgingival element is further intended to support a prosthetic element.

Preferably, said transgingival element is a cervix that protrudes from the cervical implant end and that is positioned in the extension of the coronal portion of the anchoring body.

Advantageously, the transgingival element is a pier connected, preferably removably, by a connecting means to said coronal portion of the anchoring body.

Other embodiments of the prosthetic assembly according to the invention are indicated in the appended claims.

Other features and advantages of the invention will emerge from the description provided below, non-limitingly.

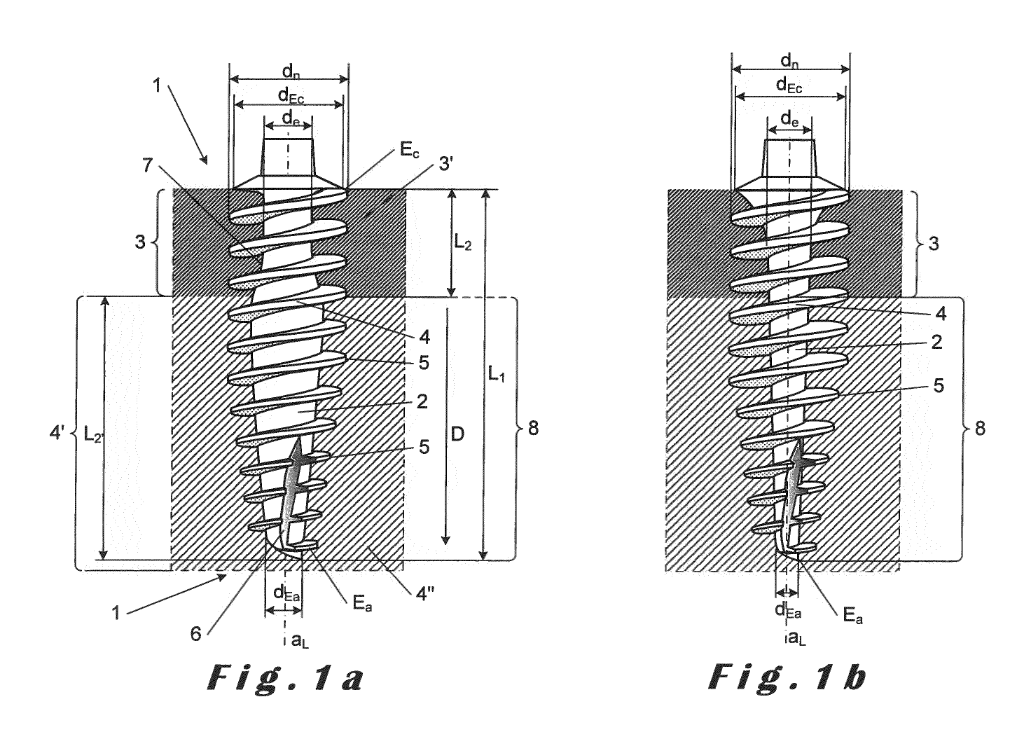

FIG. 1 illustrates a first embodiment of the implant according to the invention.

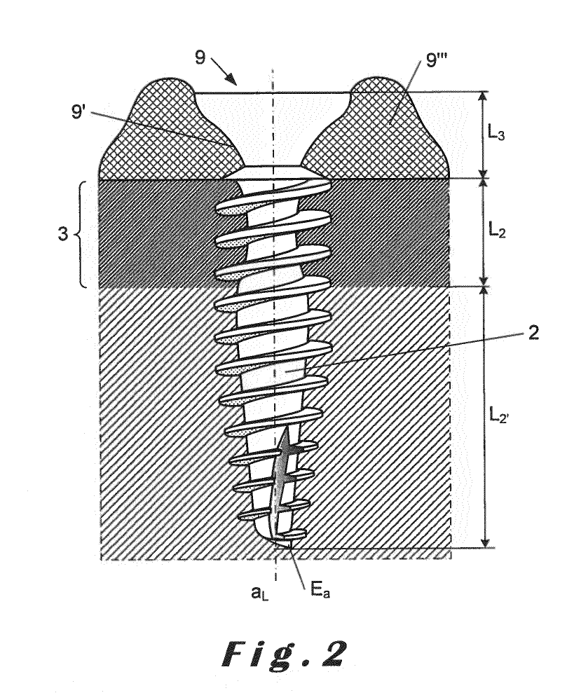

FIG. 2 illustrates a first embodiment of the prosthetic assembly according to the invention.

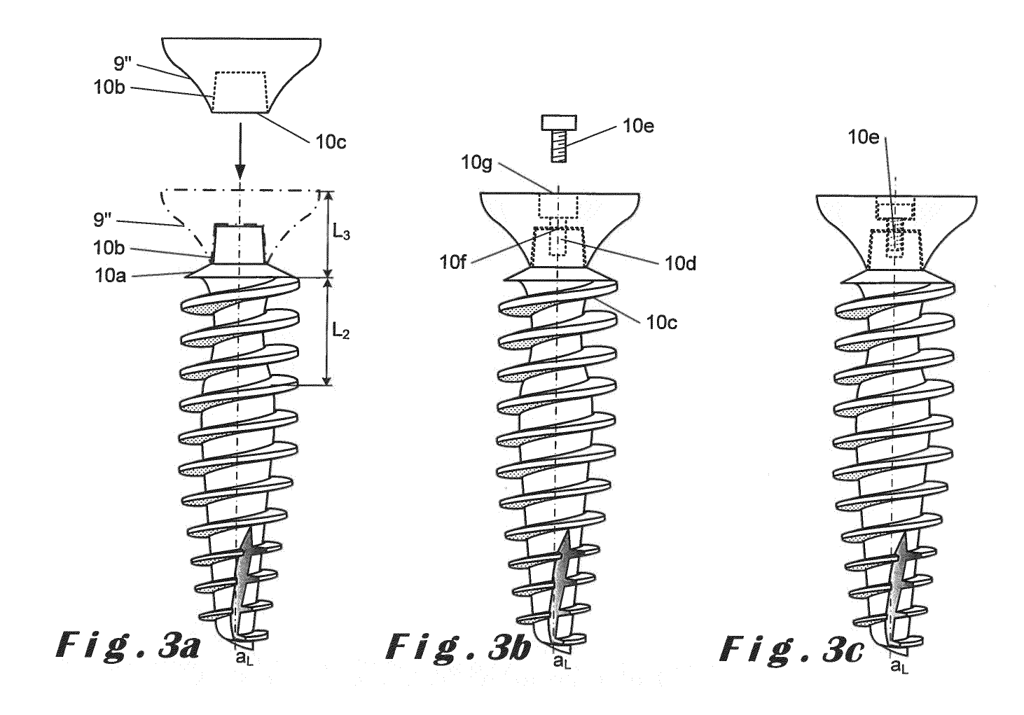

FIG. 3 illustrates a second embodiment of the prosthetic assembly according to the invention.

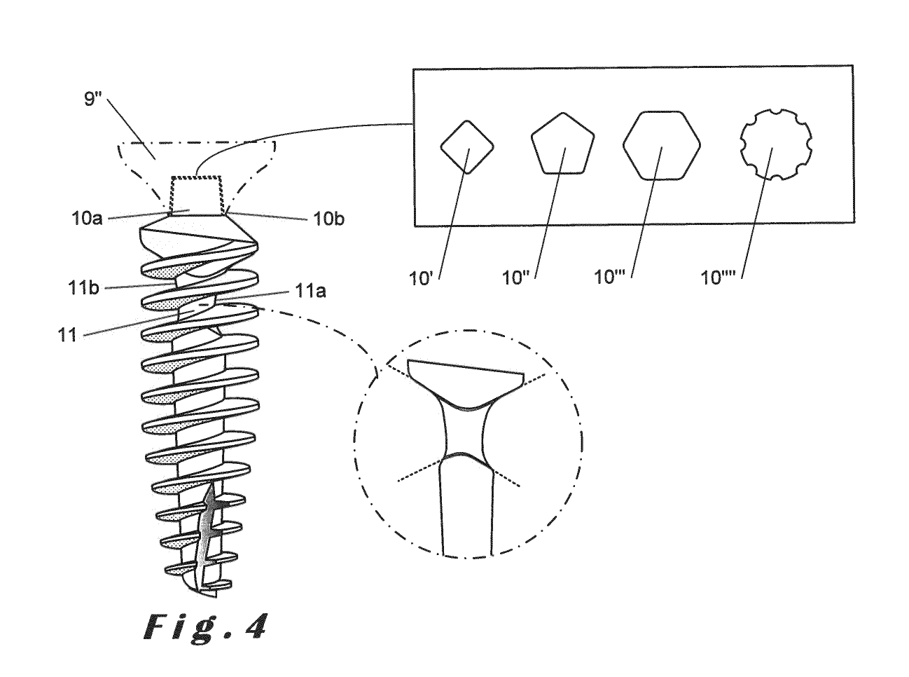

FIG. 4 illustrates a third embodiment of the prosthetic assembly according to the invention.

In the figures, similar elements bear the same reference.

FIGS. 1a and 1b illustrate a first embodiment of the implant 1 according to the invention. In these figures, the anchoring body 2 is identified with a first length L₁ generally comprised between 10.00 mm and 15.00 mm, forming the implant defined by an apical end Eₐ and a cervical end E_{c} connected to one another by a longitudinal axis a_{L}.

This longitudinal axis a_{L}, which traverses the anchoring body 2 from the apical end Eₐ toward the cervical end E_{c}, corresponds to the rotation axis of a thread 4 present on an outer surface over the entire length of the anchoring body 2.

The thread 4 is a positive pitch thread, i.e., that screws in a drilling direction D when the screw is rotated clockwise around the rotation axis a_{L}.

The anchoring body 2 has, over at least a coronal portion 3 that extends over a second length L₂ from 2.00 mm to 5.00 mm, a portion of the thread 4 having a threading (with turns) with nominal diameter dₙ larger than an outer diameter dₑ of the anchoring body 2 at a first ratio R₁=dₙ/dₑ comprised between 2.00 and 4.00, preferably between 2.00 and 3.90, advantageously between 2.00 and 3.80, more advantageously between 2.00 and 3.70, alternatively between 2.00 and 3.60, in one particular embodiment between 2.00 and 3.50.

Optionally, the first ratio R₁=dₙ/dₑ is comprised between 2.00 and 3.40, preferably between 2.00 and 3.30, more advantageously between 2.00 and 3.20, alternatively between 2.00 and 3.10, optionally between 2.00 and 3.00.

Optionally, the first ratio R₁=dₙ/dₑ is comprised between 2.00 and 3.00.

Preferably, the first ratio R₁=dₙ/dₑ is comprised between 2.00 and 2.90, preferably between 2.00 and 2.80, advantageously between 2.00 and 2.70, more advantageously between 2.00 and 2.60, alternatively between 2.00 and 2.50, in one particular embodiment between 2.00 and 2.40.

Optionally, the first ratio R₁=dₙ/dₑ is comprised between 2.00 and 2.30, preferably between 2.00 and 2.20, more advantageously between 2.00 and 2.10.

The first ratio R₁=dₙ/dₑ is more preferably equal to 2.00 or 2.50.

The first ratio R₁=dₙ/dₑ is still more preferably equal to 3.00 or 3.50.

The first ratio R₁=dₙ/dₑ is still more advantageously equal to 4.00.

The length L₂ corresponds to the mean thickness of the cortical bone of the jaw.

The nominal diameter is the diameter measured between two peak ends of the thread.

Preferably, the nominal diameter dₙ of the thread has a value comprised in a range from 2.50 mm to 6.00 mm, preferably in a range from 4.00 mm to 5.00 mm. The outer diameter D of the anchoring body 2 is preferably chosen in a range from 1.20 mm to 3.00 mm.

Preferably, the thread, having the ratio R₁=dₙ/dₑ defined above, is present over at least the entire length L₂ of the coronal portion 3 of the implant 1.

Advantageously, the thread, having the ratio R₁=dₙ/dₑ defined above, is present over the entire length L₁ of the implant.

The anchoring body 2 is preferably a solid body made from titanium or zirconium with a conical shape having a taper converging toward said apical end Eₐ. In particular, the anchoring body 2 has an apical end outer diameter d_{Ea} comprised between 1.50 mm and 2.00 mm and a cervical end outer diameter d_{Ec} comprised between 2.50 mm and 3.00 mm.

The thread 4 is further characterized by a second ratio R₂=n/L₁ comprised between 0.50 mm⁻¹ and 1.00 mm⁻¹, preferably between 0.60 mm⁻¹ and 1.00 mm⁻¹, advantageously between 0.70 mm⁻¹ and 1.00 mm⁻¹, n representing a predetermined number of peaks 5 of the thread 4.

The ratio R₂ therefore represents the density of peaks per unit of length of the implant. For example, for an implant with length L₁ equal to 10.00 mm, a ratio R₂ of 0.50 mm⁻¹ means that over the length L₁, a thread is formed comprising 5 peaks.

A ratio R₂ of 1.00 mm⁻¹ means that over a length L₁ equal to 10.00 mm, a thread is formed comprising 10 peaks.

Advantageously, the thread 4 is further characterized by a third ratio R₃=n/L₂ comprised between 0.50 mm⁻¹ and 1.00 mm⁻¹, preferably between 0.60 mm⁻¹ and 1.00 mm⁻¹, advantageously between 0.70 mm⁻¹ and 1.00 mm⁻¹, n representing a predetermined number of peaks 5 of the thread 4.

The ratio R₃ therefore represents the density of peaks per unit of length L₂ of the coronal portion 3 of the implant. For example, for a coronal portion 3 with length L₂ equal to 3.00 mm, a ratio R₃ of 0.50 mm⁻¹ means that over the length L₂, a thread is formed comprising 1.5 peaks.

A ratio R₃ of 1.00 mm⁻¹ means that, over a length L₂ equal to 5.00 mm, a thread is formed comprising 5 peaks.

Preferably, the anchoring body 2 has, at its apical end Eₐ, at least one tapping notch 6 made up of a longitudinal recess arranged from the apical end Eₐ toward the cervical end E_{c} of the anchoring body 2.

This second apical portion 8 is typically anchored in the cancellous bone part 4″ with a predefined depth 4′ of the jaw.

This second apical portion is further defined by a length L_{2′} that depends on the depth 4′ of the cancellous bone part 4″.

In this context, the length L₁=L₂+L_{2′} of the implant therefore depends on the one hand on the depth of the hard cortical bone 3′ of the jaw, and on the other hand on the depth 4′ of the cancellous bone part 4″ of the jaw.

Preferable, the second apical portion 8 has a cylindrical or conical shape with a taper converging towards apical end Eₐ.

FIGS. 2 and 3 illustrate two different embodiments of the prosthetic assembly comprising:
the implant 1 according to the invention; and
a transgingival element 9 arranged to be connected to the coronal portion 3 of the anchoring body 2 and intended to support a prosthetic element.

The transgingival element 9 has a third length L₃ equal to a gum thickness 9′″ of the implantation site. In general, this third length L₃ is comprised between 3.0 mm and 4.00 mm.

In a first embodiment of the assembly according to the invention (FIG. 2), the assembly is an assembly of the “Tissue Level” type and comprises a transgingival element 9 assuming the form of a cervix 9′ protruding in the extension of the first coronal portion 3 of the anchoring body 2, along the longitudinal axis a_{L}, in a direction opposite the apical end Ea of the anchoring body 2. In this way, the prosthesis cervix 9 and the anchoring body 2 form a single body.

In a second embodiment of the assembly according to the invention (FIGS. 3a to 3c), the assembly is an assembly of the “Bone Level” type where the transgingival element 9 is a pier 9″ connected, preferably removably, by a first connecting means 10 to the coronal portion 3 of the anchoring body 2.

The first connecting means 10 that connects the pier 9″ to the coronal portion 3 of the anchoring body 2 comprises a head body 10a protruding from the cervical end E_{c} of the anchoring body 2 along said longitudinal axis a_{L}, and having a beveled base shaped obliquely relative to a horizontal plane passing through the cervical end E_{c} of the anchoring body 2. The head body 10a protrudes in a direction opposite the apical end Eₐ of the anchoring body 3. The head body 10a is further arranged to nest in a first cavity 10b present in the pier 9″ through a cavity opening 10c of the pier (FIG. 3a). Preferably, the head body 10a assumes a conical shape and the first cavity 10b of the pier has a shape complementary to that of the head body 10a. Preferably, the taper of the head body 10a is greater than 0%, preferably comprised between 0.10% and 10%.

The taper C of a cone is defined in the context of the present invention as follows:

C (in %)=[(d−D′)/H]×100

where d corresponds to the basal diameter of the cone;
D′ corresponds to the cervical end diameter of the cone; and
H corresponds to the height of the cone.

Preferably, the head body 10a further comprises a second threaded cavity 10d arranged to accommodate the screw 10e, having a square body and a screw head, through an opening 10f of the head body 10a cavity 10d. The pier 9″ has an orifice 10g providing access to the cavity 10d of the head body 10a, such that the pier 9″ can be connected by bearing on the head body 10a via the screw head 10e, which, once screwed into the second cavity 10d of the head body 10a, compresses an apical surface part of the pillar 9″ on the head body (FIGS. 3b and 3c).

Alternatively (not shown), the pier 9″ is provided, on its base, with an apical element protruding from the base and arranged to be housed in a cavity formed in the coronal portion of the implant, through an opening defined on the cervical end of the implant.

FIG. 4 illustrates a third embodiment of the prosthetic assembly in a truncated view.

In this embodiment, the coronal portion 3 of the implant is defined by a side wall 11 that has a first vestibular face 11a and a second palatine face 11b, said palatine face 11b being in a position offset toward the cervical end E_{c} relative to that of the vestibular face 11a along the longitudinal axis a_{L}.

The palatine face is the face that is intended to be oriented toward the hard palate of the buccal cavity after the implant is placed.

The vestibular face is the face opposite the palatine face.

Furthermore, in this type of implant, the concavity of the coronal portion has a dual slope.

Furthermore, as illustrated in FIG. 4, advantageously, the head body 10a has at least one part characterized by a substantially polygonal transverse section (square 10′, pentagonal 10″, hexagonal 10′″), the cavity 10b of the pier having a polygonal shape complementary to that of the head body 10a. As shown by this figure, the cross-sections have scalloped polygonal cross-sections that have rounded edges assuming the form of bevels.

For all of the embodiments described above, an osteostimulating material can be arranged on the surface of the anchoring body, in particular on the surface of the coronal portion of the implant, so as to stimulate bone regrowth once the implant is placed on the implantation site. In this context, the space created between the peaks of the turns of the thread constitutes reservoirs of osteo-stimulating material.

### Comparisons by Modeling a Traditional Dental Implant from the State of the Art with a Dental Implant According to the Invention

Finite element models (using the Samcef software, version 16, by the firm SAMTECH) were done on three-dimensional implant models (done using the CREO software, version 2, by the firm PTC) in order to compare, at the mechanical level, a traditional dental implant of the state of the art and an implant according to the invention, these two implants being made from a Ti6AL4V titanium alloy (with a Young's modulus set at 110 GPa for the calculation).

These models were done in order to determine and compare (1) the overall contact surfaces of the dental implant with the dense bone and the cancellous bone, (2) the compression stresses exerted on the one hand on the dense bone and on the other hand on the cancellous bone, and (3) the compression stresses exerted within the dental implant itself when a predetermined force is applied along the longitudinal axis (a_{L}) of the dental implant at its cervical end (E_{c}).

The force considered and applied in the context of these finite element models was set at 150 N, which corresponds to a mean molar mastication force (Guillaume Odin. Modélisation numérique de l'os mandibulaire appliquée à l'implantologie dentaire et maxillo-faciale [Digital modeling of the mandibular bone applied to dental and maxillofacial implantology]. Modeling and Simulation. Ecole Nationale Supérieure des Mines de Paris, 2008).

The characteristics of each of these dental implants are shown in table 1 below:

TABLE 1

| | Traditional dental | Dental implant |
|---|---|---|
| | implant of | according to |
| | the state of the art | the invention |
| Length (L₁) | 8.7 mm | 8.7 mm |
| Nominal diameter (dₙ) | 4.27 mm | 4.27 mm |
| Outer diameter (dₑ) | 4 mm | 2 mm |
| Ratio dₙ/dₑ | 1.067 | 2.135 |

Furthermore, in order to perform these finite element models, the following Young's modulus values (elasticity modulus) were set for the different elements to be taken into account. The studies are provided in table 2 below:

TABLE 2

| | Young's modulus (MPa) |
|---|---|
| Dense bone | 3000* |
| Cancellous bone | 300* |
| Dental implant | 110,000 |

*Guillaume Odin. Modélisation numérique de l'os mandibulaire appliquée à l'implantologie dentaire et maxillo-faciale. Modeling and Simulation. Ecole Nationale Supérieure des Mines de Paris, 2008.

The obtained results are provided in table 3 below:

TABLE 3

| | Traditional dental | Dental implant |
|---|---|---|
| | implant of | according to |
| | the state of the art | the invention |
| Overall contact surface | 132.3 mm² | 150.3 mm² |
| (with the dense bone and | | |
| cancellous bone) | | |
| Compression stress | 83.1 MPa | 100.9 MPa |
| exerted in the dense bone | | |
| Compression stress | 6.7 MPa | 7.1 MPa |
| exerted in the cancellous | | |
| bone | | |
| Compression stress | 7.7 MPa | 8.5 MPa |
| exerted in the dental | | |
| implant | | |

As one can see, the overall contact surface of the dental implant according to the invention with the dense bone and the cancellous bone is increased. Furthermore, the compression stresses respectively exerted in the dense bone, the cancellous bone and the implant are also increased for an implant according to the invention, whose dₙ/dₑ ratio is comprised between 2 and 4 (dₙ/dₑ ratio=2.135 for the implant according to the invention considered in finite element models).

The compression increases of the dense and cancellous bone owing to a dental implant according to the invention are particularly advantageous because they make it possible to stimulate the bone tissue such that it reforms more quickly and that much better around the dental implant.

Of course, the present invention is in no way limited to the embodiments described above, and changes may be made thereto without going beyond the scope of the appended claims.

1. A dental implant formed by an anchoring body defined between an apical end and a cervical end, said anchoring body being a body with a first predetermined length and having, on its outer surface and along all of said first predetermined length, at least one thread, wherein said anchoring body comprises, over at least a coronal portion of the implant, a portion of said at least one thread with a nominal diameter that is greater than an outer diameter of said anchoring body at a first ratio comprised between 2.00 and 4.00, preferably between 2.00 and 3.00.

2. The dental implant according to claim 1, wherein said anchoring body is at least partially substantially cylindrical.

3. The dental implant according to claim 1, wherein said anchoring body has a conical-cylindrical shape or conical shape with its taper converging toward said apical end.

4. The dental implant according to claim 1, wherein said coronal portion is defined by a side wall that has a first vestibular face and a second palatine face, said palatine face being in a position offset toward said cervical end relative to that of the vestibular face along a longitudinal axis traversing the anchoring body and connecting said first cervical end to said apical end.

5. The dental implant according to claim 1, wherein said anchoring body has, at its apical end, at least one tapping notch made up of at least one longitudinal recess, preferably arranged from the apical end toward the cervical end of the anchoring body.

6. A prosthetic assembly comprising:
said implant according to claim 1; and
a transgingival element arranged to be connected to the coronal portion of the anchoring body and intended to support a prosthetic element.

7. The prosthetic assembly according to claim 6, wherein said transgingival element is a cervix that protrudes from the cervical implant end and that is positioned in the extension of the coronal portion of the anchoring body.

8. The prosthetic assembly according to claim 6, wherein said transgingival element is a pier connected, preferably removably, by a connecting means to said coronal portion of the anchoring body.
